(19) United States
(12) Patent Application Publication
(10) Pub. No.: US 2018/0160463 A1
(43) Pub. Date: Jun. 7, 2018

(54) WIRELESS CONTROL OF DEVICES

(71) Applicant: NOKIA TECHNOLOGIES OY, Espoo (FI)

(72) Inventors: Juhani HUTTUNEN, Veikkola (FI); Panu MARKKANEN, Helsinki (FI); Miraj MOSTAFA, Tampere (FI)

(21) Appl. No.: 15/569,996

(22) PCT Filed: May 4, 2015
(86) PCT No.: PCT/FI2015/050299

§ 371 Date: Oct. 27, 2017

(51) Int. Cl. H04W 76/14; H04W 8/00

(52) U.S. Cl. CPC H04W 76/14; H04W 8/005

(57) ABSTRACT

In accordance with an example aspect of the present invention, there is provided an apparatus comprising at least one receiver configured to obtain discovery information concerning a plurality of peripheral devices, at least one processing core configured to define a set of peripheral devices from among the plurality of peripheral devices, and to cause transmission, to a server, of device information concerning each peripheral device comprised in the set.

### FIELD OF INVENTION

The present invention relates to the field of wireless control of peripheral devices.

### BACKGROUND OF INVENTION

Computers may be associated with peripheral devices, such as, for example, displays, mice, keyboards and loudspeakers. Desktop computers, for example, may comprise physical connectors arranged to accept electrically conducting wiring to connect the desktop computer to peripheral devices. For example, a desktop computer may comprise a video graphics array, VGA, or a high-definition multimedia interface, HDMI, connector to connect to a display. Likewise, a universal serial bus, USB, connector may be used to interface a computer with mice, external hard drives for media storage, and other peripheral devices.

Laptop computers provide mobile computing platforms users can employ when travelling. When in the home or office, laptop computers may be connected to an external display, keyboard and mouse using wired connectors to connect the laptop separately to each peripheral device.

A docking center provides an alternative way to connect a laptop device to peripheral devices, wherein the docking center may remain on a desk at home or in the office, with peripheral devices permanently interfaced, for example using wire-line interfaces, with the docking center. A user may then interface a laptop computer, or indeed another kind of electronic device, with the docking center, to thereby interface the electronic device with the peripheral devices via the docking center. A utility is thereby obtained in that the user needs only to interface his device once, with the docking center, to obtain connectivity to several peripheral devices.

Some peripheral devices are furnished with wireless interfaces, such as for example Bluetooth and Wi-Fi interfaces. Instead of wire-line connections between peripheral devices and a docking center, the peripheral devices may be interfaced with the docking center using such a wireless interface.

### SUMMARY OF THE INVENTION

The invention is defined by the features of the independent claims. Some specific embodiments are defined in the dependent claims.

In accordance with a first aspect of the present invention, there is provided an apparatus comprising at least one receiver configured to obtain discovery information concerning a plurality of peripheral devices, at least one processing core configured to define a set of peripheral devices from among the plurality of peripheral devices, and to cause transmission, to a server, of device information concerning each peripheral device comprised in the set.

Various embodiments of the first aspect may comprise at least one feature from the following bulleted list:
the apparatus is further configured to obtain credentials for at least one of the peripheral devices comprised in the set
being configured to obtain the credentials comprises being configured to request for at least one credential from a user
the set of peripheral devices comprises a virtual docking center instance
the at least one receiver is configured to receive the device information over a low-power wireless interface
the at least one processing core is configured to cause transmission of the credentials in connection with transmission of the device information
the at least one processing core is configured to cause transmission of the device information responsive to a user interface input
being configured to cause transmission of the credentials in connection with transmission of the device information comprises being configured to cause transmission of the credentials and the device information comprised in a single message.

In accordance with a second aspect of the present invention, there is provided an apparatus, comprising at least one receiver is further configured to receive, from a server, an indication of a set of peripheral devices that is available, and at least one processing core configured to obtain, from the server, device information concerning the set of peripheral devices, and to cause the apparatus to connect directly with the set of peripheral devices based at least in part on the device information to initiate a wireless docking session.

Various embodiments of the second aspect may comprise at least one feature from the following bulleted list:
the indication comprises an identifier of the set of peripheral devices
the at least one processing core is configured to cause transmission, toward the server, of at least one identifier of at least one peripheral device comprised in the set of peripheral devices, and the apparatus is configured to responsively receive the indication
the apparatus is configured to inquire from a user whether to connect with the set of peripheral devices
the apparatus is configured to obtain from the server at least one of: credentials, device information, connectivity information and access information concerning the available set of peripheral devices
the apparatus is configured to control the available set of peripheral devices, at least in part, using at least one of: the credentials, other device information, connectivity information and access information
the apparatus is configured to connect with the set of peripheral devices using direct low-power wireless connections, the direct low-power wireless connections not traversing any nodes between the apparatus and the peripheral devices comprised in the set of peripheral devices.

In accordance with a third aspect of the present invention, there is provided an apparatus, comprising a receiver configured to receive, from a device, device information concerning peripheral devices comprised in a set of peripheral devices, a memory arranged to store an identifier associated with the set of peripheral devices, and at least one processing core configured to, responsive to a message, cause transmission of the identifier.

Various embodiments of the third aspect may comprise at least one feature from the following bulleted list:
the receiver is further configured to receive credentials for at least one of the peripheral devices comprised in the set
the at least one processing core is configured to, responsive to the message from the device, cause transmission of at least one of: credentials, device information, connectivity information and access information concerning the available set of peripheral devices
the message comprises an inquiry as to whether a wireless docking opportunity exists
the message comprises second device information, and the at least one processing core is configured to compare the device information to the second device information.

In accordance with a fourth aspect of the present invention, there is provided a method, comprising obtaining discovery information concerning a plurality of peripheral devices, defining a set of peripheral devices from among the plurality of peripheral devices, and causing transmission, to a server, of device information concerning each peripheral device comprised in the set.

Various embodiments of the fourth aspect may comprise at least one feature corresponding to a feature from the preceding bulleted list laid out in connection with the first aspect.

In accordance with a fifth aspect of the present invention, there is provided a method, comprising receiving, in an apparatus, from a server, an indication of a set of peripheral devices that is available, obtaining, from the server, device information concerning the set of peripheral devices, and causing the apparatus to connect directly with the set of peripheral devices based at least in part on the device information to initiate a wireless docking session.

Various embodiments of the fifth aspect may comprise at least one feature corresponding to a feature from the preceding bulleted list laid out in connection with the second aspect.

In accordance with a sixth aspect of the present invention, there is provided a method, comprising receiving, from a device, device information concerning peripheral devices comprised in a set of peripheral devices, storing an identifier associated with the set of peripheral devices, and causing transmission of the identifier, responsive to a message.

Various embodiments of the sixth aspect may comprise at least one feature corresponding to a feature from the preceding bulleted list laid out in connection with the third aspect.

In accordance with a seventh aspect of the present invention, there is provided an apparatus comprising means for obtaining device information concerning a plurality of peripheral devices, means for defining a set of peripheral devices from among the plurality of peripheral devices, and means for causing transmission, to a server, of device information concerning each peripheral device comprised in the set.

In accordance with an eighth aspect of the present invention, there is provided an apparatus comprising means for receiving, from a server, an indication of a set of peripheral devices that is available, means for obtaining, from the server, device information concerning the set of peripheral devices, and means for causing the apparatus to connect directly with the set of peripheral devices based at least in part on the device information to initiate a wireless docking session.

In accordance with a ninth aspect of the present invention, there is provided an apparatus comprising means for receiving, from a device, device information concerning peripheral devices comprised in a set of peripheral devices, means for storing an identifier associated with the set of peripheral devices, and means for causing transmission of the identifier to the device, responsive to a message from the device.

In accordance with a tenth aspect of the present invention, there is provided a non-transitory computer readable medium having stored thereon a set of computer readable instructions that, when executed by at least one processor, cause an apparatus to at least obtain device information concerning a plurality of peripheral devices, define a set of peripheral devices from among the plurality of peripheral devices, and cause transmission, to a server, of device information concerning each peripheral device comprised in the set.

In accordance with an eleventh aspect of the present invention, there is provided a non-transitory computer readable medium having stored thereon a set of computer readable instructions that, when executed by at least one processor, cause an apparatus to at least receive, from a server, an indication of a set of peripheral devices that is available, obtain, from the server, device information concerning the set of peripheral devices, and cause the apparatus to connect directly with the set of peripheral devices based at least in part on the device information to initiate a wireless docking session.

In accordance with a twelfth aspect of the present invention, there is provided a non-transitory computer readable medium having stored thereon a set of computer readable instructions that, when executed by at least one processor, cause an apparatus to at least receive, from a device, device information concerning peripheral devices comprised in a set of peripheral devices, store an identifier associated with the set of peripheral devices, and cause transmission of the identifier to the device, responsive to a message from the device.

In accordance with a thirteenth aspect of the present invention, there is provided a computer program configured to cause a method in accordance with at least one of the fourth, fifth and sixth aspects to be performed, when run.

### INDUSTRIAL APPLICABILITY

At least some embodiments of the present invention find industrial application in facilitated wireless control of peripheral devices, for example in obviating a need for a physical wireless docking centre.

### BRIEF DESCRIPTION OF THE DRAWINGS

FIG. 1 illustrates an example system capable of supporting at least some embodiments of the present invention;

FIG. 2 illustrates a second example system capable of supporting at least some embodiments of the present invention;

FIG. 3 illustrates an example apparatus capable of supporting at least some embodiments of the present invention;

FIG. 4 illustrates signalling in accordance with at least some embodiments of the present invention;

FIG. 5 is a first flow chart of a first method in accordance with at least some embodiments of the present invention;

FIG. 6 is a second flow chart of a second method in accordance with at least some embodiments of the present invention, and

FIG. 7 is a third flow chart of a second method in accordance with at least some embodiments of the present invention.

### DETAILED DESCRIPTION OF EXAMPLE EMBODIMENTS

By associating wireless peripheral devices in a certain location into a wireless docking set or instance, for example in a server device, a separate wireless docking centre or wireless docking centre device may no longer be needed. Rather, a wireless-enabled device can assume control of the wireless peripheral devices comprised in the wireless docking set by connecting to them using direct wireless connections that do not traverse any separate wireless docking centre or wireless docking centre device.

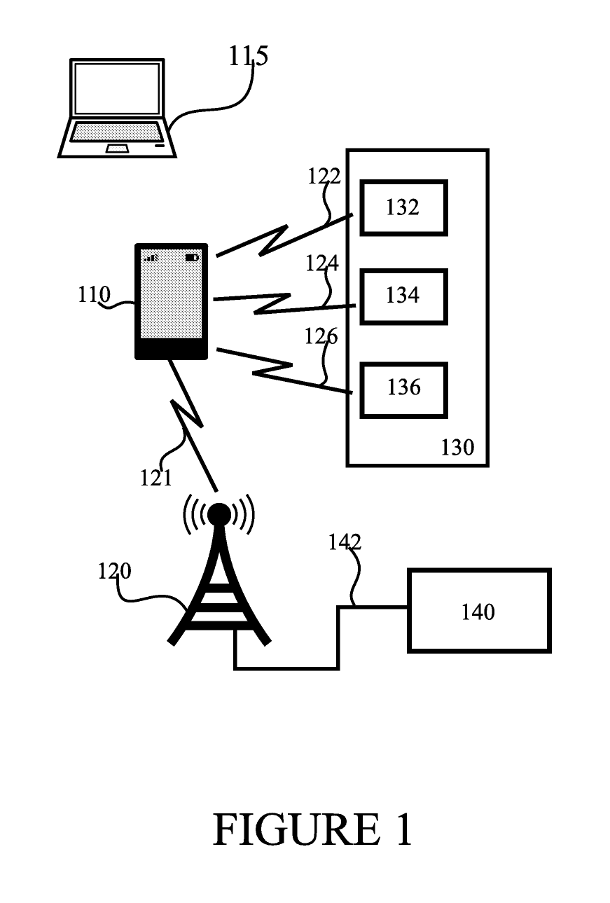

FIG. 1 illustrates an example system capable of supporting at least some embodiments of the present invention. The system of FIG. 1 comprises device 110, which may comprise, for example, a smartphone, tablet computer, laptop computer, mobile phone or other electronic device capable of controlling peripheral devices.

A set of peripheral devices 130 is disposed in a vicinity of device 110. For example, the vicinity of device 110 may comprise an area of approximately ten meters. As another example, being disposed in the vicinity of device 110 may comprise that the set of peripheral devices is in range of a wireless communications technology device 110 is configured to use, such as for example a low-power wireless communications technology. Examples of low-power wireless communications technologies comprise Bluetooth, Bluetooth-low power, near-field communications, NFC, wireless local area network, WLAN, also known as Wi-Fi, and Wibree.

The set of peripheral devices 130 comprises peripheral devices 132, 134 and 136. The set may comprise, alternatively to three, another number of peripheral devices such as two or five peripheral devices. For example, these peripheral devices may comprise at least one of a television, a computer monitor, a media playback device, a keyboard, a mouse or other pointing device, a printer, a clock, a pair of headphones and a data storage device, such as, for example, a magnetic hard drive. Although associated with each other in FIG. 1 by reference number 130, peripheral devices 132, 134 and 136 needn't be directly associated with each other in the sense that there would exist direct communication interfaces between the peripheral devices.

The set of peripheral devices 130 being in the vicinity of device 110, device 110 is in the system of FIG. 1 in direct wireless contact with each of peripheral devices 132, 134 and 136. In detail, wireless link 122 interconnects device 110 with peripheral device 132, wireless link 124 interconnects device 110 with peripheral device 134 and wireless link 126 interconnects device 110 with peripheral device 136. Each of wireless links 122, 124 and 126 may operate in accordance with a wireless communication standard that device 110 and the respective peripheral device supports. The wireless links needn't function in accordance with the same standard. For example, wireless link 122 may operate in accordance with the Bluetooth standard, wireless link 124 may operate in accordance with the wireless local area network, WLAN, standard, and wireless link 126 may operate in accordance with a further standard.

Device 110 is in the system of FIG. 1 further enabled to communicate in accordance with a cellular standard, such as for example wideband code division multiple access, WCDMA, or long term evolution, LTE. Cellular wireless link 121 enables two-way wireless communication between device 110 and base station 120. Base station 120 is configured to operate in accordance with the same standard as cellular wireless link 121. Base station 120 may be comprised in a radio access network of a cellular communications network.

Base station 120 is in communication with server 140 via connection 142. Server 140 may comprise a cloud service server, for example. Connection 142, which may comprise, for example, a wire-line or at least in part wireless connection, may traverse intermediate nodes and/or networks, which are not illustrated in FIG. 1 for the sake of clarity. Such intermediate nodes and/or networks may comprise, for example, a core network node, such as a switch or mobility management entity, and/or a corporate or internet service provider, ISP, network.

In use, device 110 may perform passive or active device discovery procedures, such as for example Wi-Fi direct service of Bluetooth service discovery procedures. When in the vicinity, or range, of at least one peripheral device, device 110 may determine, from the discovery procedure, discovery information concerning at least one peripheral device. Such discovery information may comprise, for example, an identifier of the peripheral device and/or a type of the peripheral device. Discovery information may comprise capability information describing capabilities of the peripheral device. Discovery information may comprise an indication as to whether controlling the peripheral device requires a credential. Discovery information may be considered an example of device information concerning the at least one peripheral device.

Device 110 may be configured to provide to a user of device 110 an indication of peripheral devices concerning which discovery information has been obtained in the present location. A user may select a subset or all of the indicated peripheral devices to form a set of peripheral devices. Device 110 may responsively associate the peripheral devices comprised in this set together, for example in a data structure stored in a memory accessible to device 110. Alternatively to a user selecting the subset, device 110 may select the subset, for example based on preconfigured information in device 110. For example, device 110 may store a list of peripheral device types needed for a certain type of docking session, and responsive such a set being discovered in the vicinity, device 110 may responsively associate the peripheral devices comprised in this set together.

In case at least one of the peripheral devices comprised in the set requires credentials for use, device 110 may obtain the credentials. For example, device 110 may obtain the credentials by requesting them from an administrative user and/or the user of device 110, or device 110 may obtain the credentials by requesting them from a credential repository. When querying a credential repository, device 110 may employ public-key cryptography to prove its identity to the credential repository. Where the user owns the peripheral devices, it may be a reasonable assumption the user has access to the credentials and is thereby authorized to control these peripheral devices.

The set of peripheral devices may correspond to a docking center instance, such as for example a wireless docking center instance. In some embodiments, the set of peripheral devices together with the credentials corresponds to the docking center instance.

Device 110 may be configured to, for example responsive to a user input, cause transmission of discovery information of the peripheral devices comprised in the set to server 140, for example, via base station 120. In some embodiments, the discovery information is caused to be transmitted together with the credentials, for example, in a single message that comprises both the discovery information and the credentials. An internet protocol, IP address or domain name of server 140 may be pre-configured in device 110, or may be provided by a user or by a technical support employee, for example, to enable communication from device 110 to server 140.

In some embodiments, the discovery information and/or credentials are transmitted to server 140 in encrypted format. For example, device 110 may be configured to obtain a public key of server 140, encrypt the discovery information and/or credentials with the public key of server 140 and transmit the thus encrypted information to server 140. The encrypted information may be signed with a secret key of device 110 and/or furnished to server 140 together with a public key of device 110.

Server 140 may acknowledge receipt of the discovery information and/or credentials by assigning a docking center instance identifier to the set of peripheral devices. A device that uses the docking center instance identifier to initiate a docking session need not be the same device as the device that transmits the discovery information and/or credentials to server 140. For example, in terms of FIG. 1, device 110 may transmit the discovery information and/or credentials to server 140 and device 115 may subsequently use the docking center instance identifier to initiate a wireless docking session. Sets of peripheral devices with discovery information and/or credentials thereof stored in server 140 and assigned docking center instance identifiers may be considered as registered in server 140. Server 140 may have stored thereon a plurality of registered docking center instances. In effect, server 140 may comprise a wireless docking server.

When device 110 leaves the vicinity of peripheral devices 130, and subsequently returns, device 110 may receive wirelessly discovery information of at least some, and possibly all, of the peripheral devices comprised in the set. Device 110 may provide the thus received discovery information to server 140, which may match this discovery information with discovery information previously provided. In case of a match, server 140 may provide to device 110 the docking center instance identifier assigned to the set of peripheral devices. Responsively, device 110 may prompt the user to approve a docking session with the set of peripheral devices comprised in the set. Alternatively, device 110 may automatically initiate the docking session with the peripheral devices comprised in the set, optionally indicating this to the user via a user interface of device 110. When the device using the docking center instance identifier is not the same device as the device that registered the docking center instance identifier, the device using the docking center instance identifier may be authorized to obtain the credentials by registering an identifier of this using device, such as for example device 115, in the information stored in server 140 in connection with the information characterizing the docking center instance identifier. Thus, server 140 may store a set of device identifiers in connection with a docking center instance identifier, the devices thus identified being thereby authorised to use the docking center instance identifier. In some embodiments, devices may be authorized to use docking center instance identifiers via a subscription, such as a user subscription, to a docking service.

Device 110 may store a nickname for a docking center instance which device 110 may use when querying the user whether to initiate a docking session. Device 110 may store a mapping between the docking center instance identifier and the nickname to facilitate decision-making by the user. Thus the user may be prompted whether docking with “Workspace” should be initiated, rather than whether docking with “232048220” should be initiated.

Where credentials were provided to server 140 in connection with registering the set of peripheral devices, the credentials may be provided from server 140 to device 110 or device 115 in connection with device 110 or device 115 deciding to initiate a docking session with the set or peripheral devices. Alternatively, device 110 may store copies of the credentials in a memory comprised in device 110, however, this implementation option risks compromising the credentials in case device 110 is stolen or lost. Providing the credentials to server 140 thus provides the benefit, or utility, that access security of the peripheral devices is improved since the credentials need not be stored on device 110 or device 115 persistently.

In some embodiments, device 110 or device 115 may be in the vicinity of more than one set of peripheral devices at a given time. In such a case, server 140 may provide identifiers of each set to device 110 or device 115, and device 110 or device 115 may then decide to initiate a docking session with one or more of the identified sets. Such a decision may be based, at least in part, on user input.

A device may report to server 140 an identifier of a peripheral device, or a group of peripheral devices, that it encounters, and server 140 may responsively determine whether the peripheral is comprised in a set of peripheral devices registered under a docking center instance identifier. Server 140 may provide the docking center instance identifier to the device. A properly authenticated and/or authorized user device can then get connectivity information and credentials of the peripherals belonging to the docking center instance identifier. The device may obtain the identifier of a peripheral device, or a group of peripheral devices, over a radio interface, or, alternatively or additionally, the device may obtain the identifier of a peripheral device, or a group of peripheral devices, by visually scanning a printed identifier. In some embodiments, a user of the device may enter the identifier of a peripheral device, or group of peripheral devices, based on observing the identifier printed on the peripheral device, or next to a group of peripheral devices.

The docking center instance identifier may logically correspond to a physical docking center device into which a set of peripheral devices may be connected to in a traditional docking solution. By docking with a physical docking center device an apparatus can initiate a docking session with the set of peripheral devices connected thereto. Analogously, by choosing to initiate a docking session with the set of peripheral devices associated with a docking center instance identifier, device 110 may initiate a docking session with the set of peripheral devices associated with the identifier, via direct wireless links between device 110 and the peripheral devices. In other words, by employing the docking center instance identifier, a benefit may be obtained in that no separate physical docking center device is needed, but device 110 may still be interfaced with a plurality of peripheral devices.

In some embodiments, the user of device 110 or device 115 may initiate a docking session by interacting with a user interface element of device 110 or device 115. In these embodiments, device 110 or device 115 may, responsive to the user interaction, signal to server 140 to inquire whether a docking session would be available. Device 110 or device 115 may furnish server 140 with some current discovery information obtained from the current vicinity of device 110 or device 115 to enable server 140 to perform matching against sets of peripheral devices registered in server 140. In case the furnished discovery information matches with discovery information in a registered set, server 140 may responsively indicate to device 110 or device 115 the docking center instance identifier of that set, to enable device 110 or device 115 to initiate a docking session with that set.

In some embodiments, device 110 or device 115 stores the docking center instance identifier and at least in part the discovery information of peripheral devices comprised in the set, to facilitate future dockings. In these embodiments, device 110 or device 115 may indicate the docking center instance identifier to server 140 to trigger initialization of a docking session, responsive to a determination, in device 110 or device 115, that device 110 or device 115 is in the vicinity of peripheral devices comprised in the set.

In general, server 140 may associate an identity of a device with a registered docking center instance to authorise the device to use the registered docking center instance, such that the registered docking center instance is not offered to a device whose identity is not associated with the docking center instance in server 140.

In case device 110 is capable of forming a direct wireless connection to only a subset of the peripheral devices comprised in a set, the docking session need not fail as device 110 is nonetheless enabled to control the peripheral devices it can communicate with.

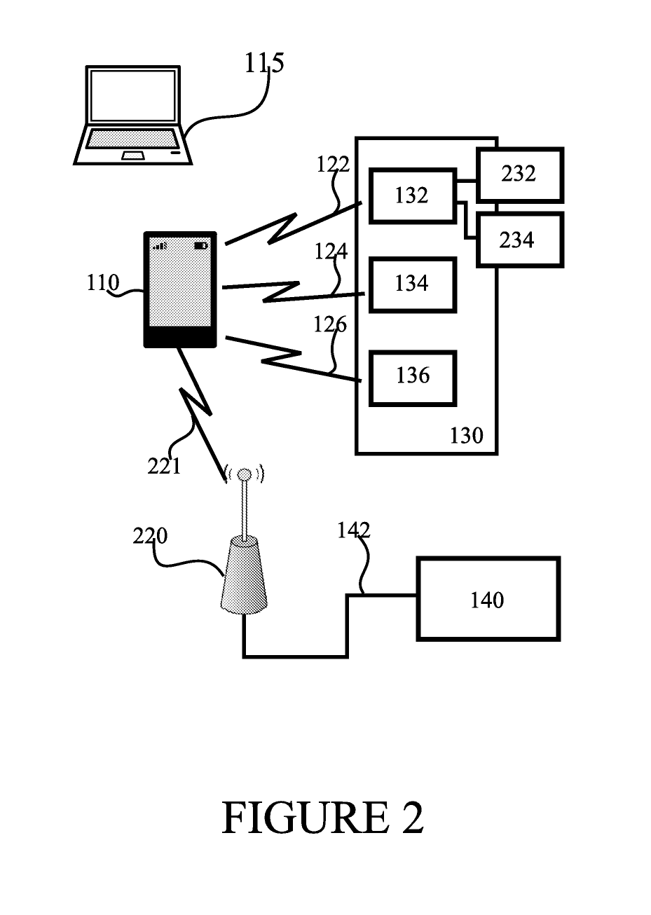

FIG. 2 illustrates a second example system capable of supporting at least some embodiments of the present invention. Like reference numbers denote like structure as in FIG. 1. In the system of FIG. 2, device 110 is configured to communicate with server 140 via wireless access point 220, rather than a cellular base station. Wireless access point 220 may be configured to operate in accordance with a non-cellular standard, such as, for example, WLAN or worldwide interoperability for microwave access, WiMAX. Access point 220 provides access to server 140 for device 110 and performs a similar role as base station 120 does in the system of FIG. 1. In further embodiments, a connection between device 110 and access point 220 may be wire-line, in which case the access point is a wired access point.

Further, the system of FIG. 2 differs from the system of FIG. 1 in that peripheral device 132 comprises specifically a wireless hub, to which peripheral devices 232 and 234 are connected via wire-line connections. Peripheral devices 232 and 234 may lack a wireless communications capability of their own, wherein wireless hub 132 enables their participation in a set of peripheral devices that forms a docking center instance. A wireless hub with attached peripheral devices may be present in a system like that of FIG. 1 as well.

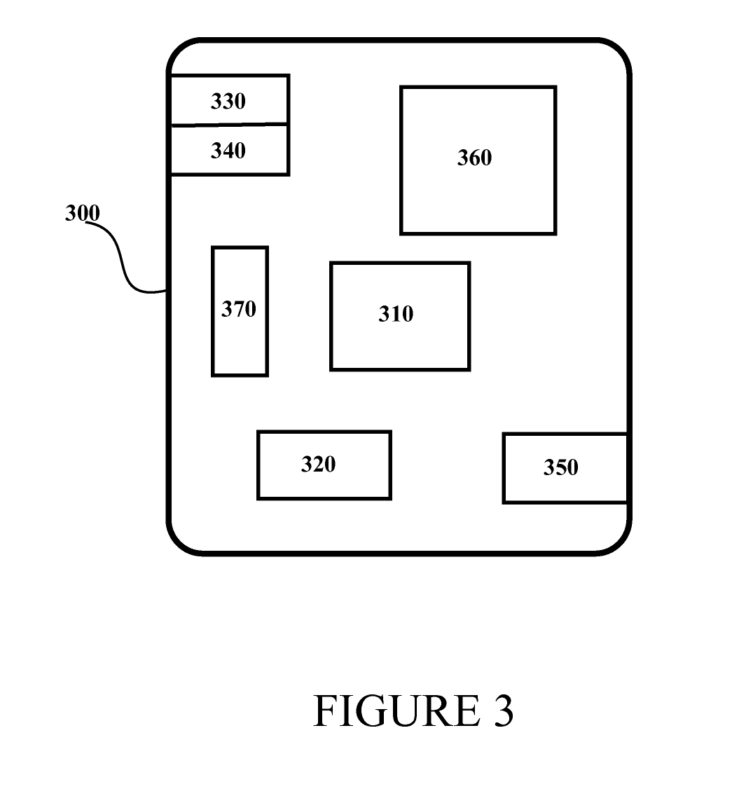

FIG. 3 illustrates an example apparatus capable of supporting at least some embodiments of the present invention. Illustrated is device 300, which may comprise, for example, a mobile device such as device 110 of FIG. 1 or FIG. 2. Some elements of the illustrated figure, such as processing cores and memory, may be employed in server 140. Comprised in device 300 is processor 310, which may comprise, for example, a single- or multi-core processor wherein a single-core processor comprises one processing core and a multi-core processor comprises more than one processing core. Processor 310 may comprise a Qualcomm Snapdragon 800 processor, for example. Processor 310 may comprise more than one processor. A processing core may comprise, for example, a Cortex-A8 processing core manufactured by ARM Holdings or a Brisbane processing core produced by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions.

Device 300 may comprise memory 320. Memory 320 may comprise random-access memory and/or permanent memory. Memory 320 may comprise at least one RAM chip. Memory 320 may comprise magnetic, optical and/or holographic memory, for example. Memory 320 may be at least in part accessible to processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, long term evolution, LTE, IS-95, wireless local area network, WLAN, Ethernet and/or worldwide interoperability for microwave access, WiMAX, standards, for example.

Device 300 may comprise a low-power wireless transceiver 350. Transceiver 350 may support at least one low-power wireless technology, such as NFC, Bluetooth, Wibree or a similar technology.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via low-power wireless transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a low-power wireless transceiver 350 and/or user identity module 370.

Processor 310, memory 320, transmitter 330, receiver 340, low-power wireless transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

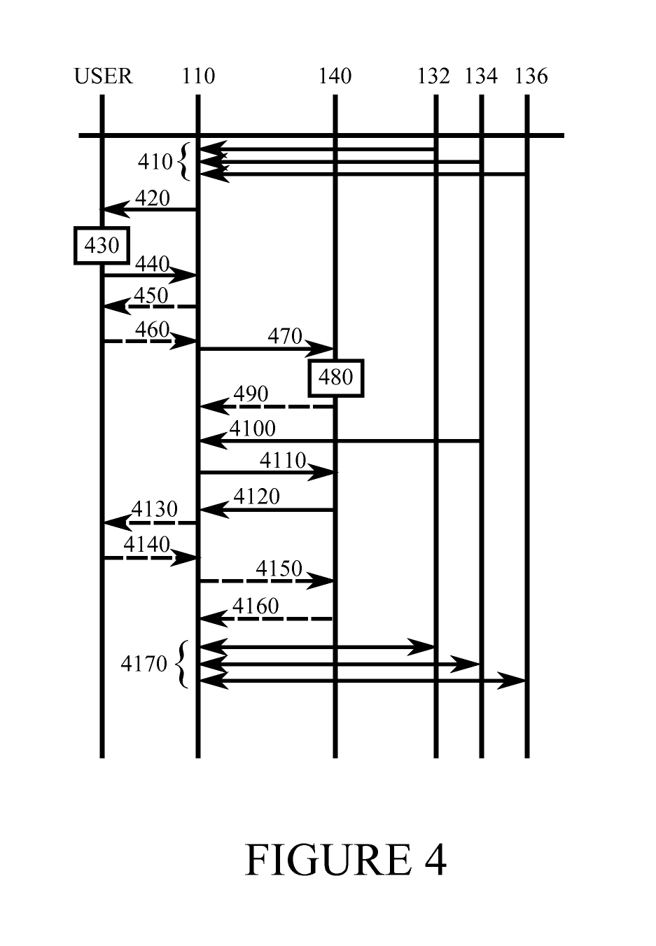

FIG. 4 illustrates signalling in accordance with at least some embodiments of the present invention. On the vertical axes are disposed, from left to right, in terms of FIG. 1 and FIG. 2, the user of device 110, USER, device 110, server 140 and peripheral devices 132, 134 and 136. Time advances from the top toward the bottom. Although illustrated as a single messaging flow, FIG. 4 may be seen to comprise two messaging flows, firstly a registration flow from phase 410 to phase 480 or 490, and secondly a docking flow from phase 4100 to phase 4170.

In phase 410, device 110 may obtain discovery information from each of peripheral devices 132, 134 and 136. In phase 420, device 110 may query from the user, which ones of peripheral devices 132, 134 and 136, if any, should be grouped together as a set to thereby define a docking center instance. In phase 430, the user indicates which peripheral devices should be associated together to form the set. In the illustrated example, the user indicates all of peripheral devices 132, 134 and 136. This is indicated to device 110 in phase 440, for example via a user interface of device 110.

In optional phases 450 and 460, device 110 queries credentials to access peripheral devices 132, 134 and 136, or at least one of them, and receives the credentials in response. Alternatively, device 110 may obtain the credentials from another source, or the peripheral devices may be usable without credentials, for example. In phase 470, device 110 provides discovery information concerning each peripheral device selected into the set to server 140. In embodiments where at least one of the peripheral devices in the set requires credentials to use, device 110 may provide such credentials to server 140 in this phase, for example in the same message with the discovery information. Responsively, in phase 480, server 140 registers the set of peripheral devices as a docking center instance, and associates a docking center instance identifier to the docking center instance. The identifier may be allocated by server 140 or by device 110, for example. In optional phase 490, server 140 acknowledges the registration of the set of peripheral devices as a docking center instance, and, optionally, informs device 110 of the docking center instance identifier associated with the newly registered docking center instance.

At a later time, in phase 4100, device 110 or another device may discover at least one of the peripheral devices comprised in the docking center instance, in the illustrated example this is peripheral device 134. As a response, in phase 4110, device 110 or the other device may inform server 140 of this, and server 140 may match the discovery information received in phase 4110 with discovery information concerning registered docking center instances to see if a match is found. In the illustrated example, peripheral device 134 is comprised in the docking center instance registered in phase 480, wherefore server 140 informs the device of a docking opportunity with this docking center instance, in phase 4120. The message of phase 4120 may comprise the docking center instance identifier, for example. The message of phase 4120 may comprise, at least in part, discovery information concerning peripheral devices comprised in the docking center instance. In general in some embodiments, if more than one docking opportunity is present, server 140 may inform the device of at least two of these docking opportunities. For example, server 140 may inform the device of all the docking opportunities. Informing of more than one docking opportunity may comprise transmitting a message 4120 concerning each of the docking opportunities.

In optional phase 4130 the device queries from the user whether to initiate a docking session with the docking center instance, and responsive to an indication to do so, phase 4140, the device may resolve to initiate a docking session. In embodiments where phases 4130 and 4140 are absent, the device may resolve to initiate a docking session responsive to the message of phase 4120. In optional phases 4150 and 4160, the device may request and receive, respectively, credentials to access at least one of the peripheral devices comprised in the docking center instance. In embodiments where phases 4150 and 4160 are absent, the device may receive the credentials in the message of phase 4120, or, alternatively, the peripheral devices comprised in the docking center instance may be accessible without credentials.

In phase 4170, the device initiates the docking session, which comprises forming direct wireless links to each of the peripheral devices comprised in the docking center instance, and at least in part controlling each of these peripheral devices. A direct wireless link may comprise, in general, that the device transmits information, from a transmitter comprised in the device, encoded in electromagnetic waves which are received and demodulated in the peripheral devices, without the electromagnetic waves being re-transmitted along the way.

In the example method illustrated in FIG. 4, the docking session is triggered by the discovery of the at least one of the peripheral devices in phase 4100. In other embodiments, a docking session may be triggered by user action, for example.

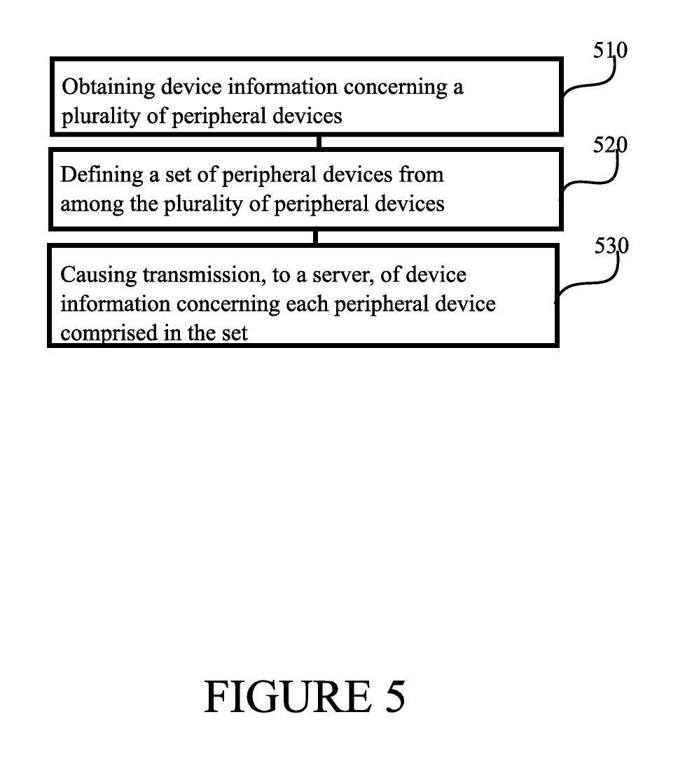

FIG. 5 is a first flow chart of a first method in accordance with at least some embodiments of the present invention. The phases of the illustrated method may be performed in device 110, for example, or in a control device, such as a processor or chipset, configured to control the functioning of device 110 when implanted therein.

Phase 510 comprises obtaining device information concerning a plurality of peripheral devices. Phase 520 comprises defining a set of peripheral devices from among the plurality of peripheral devices. Finally, phase 530 comprises causing transmission, to a server, of device information concerning each peripheral device comprised in the set.

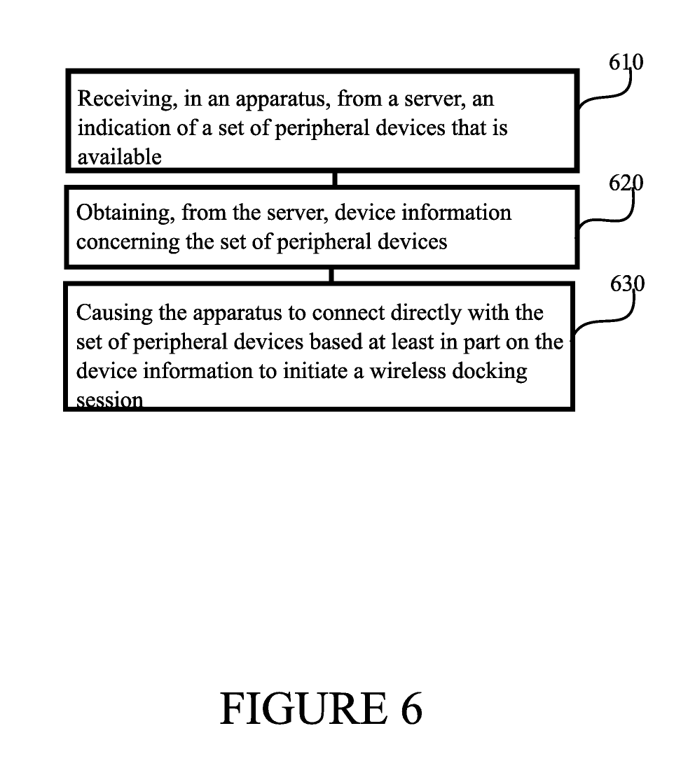

FIG. 6 is a second flow chart of a second method in accordance with at least some embodiments of the present invention. The phases of the illustrated method may be performed in device 110 or device 115, for example, or in a control device, such as a processor or chipset, configured to control the functioning of device 110 or device 115 when implanted therein.

Phase 610 comprises receiving, in an apparatus, from a server, an indication of a set of peripheral devices that is available. Phase 620 comprises obtaining, from the server, device information concerning the set of peripheral devices. The receiving of phase 620 may take place in an authenticated and authorised device, for example. The device information may comprise, as described above, at least one of credentials and connectivity information. The device information may be obtained, for example, from the same message, or alternatively another message, as the indication of phase 610. Finally, phase 630 comprises causing the apparatus to connect directly with the set of peripheral devices based at least in part on the device information to initiate a wireless docking session.

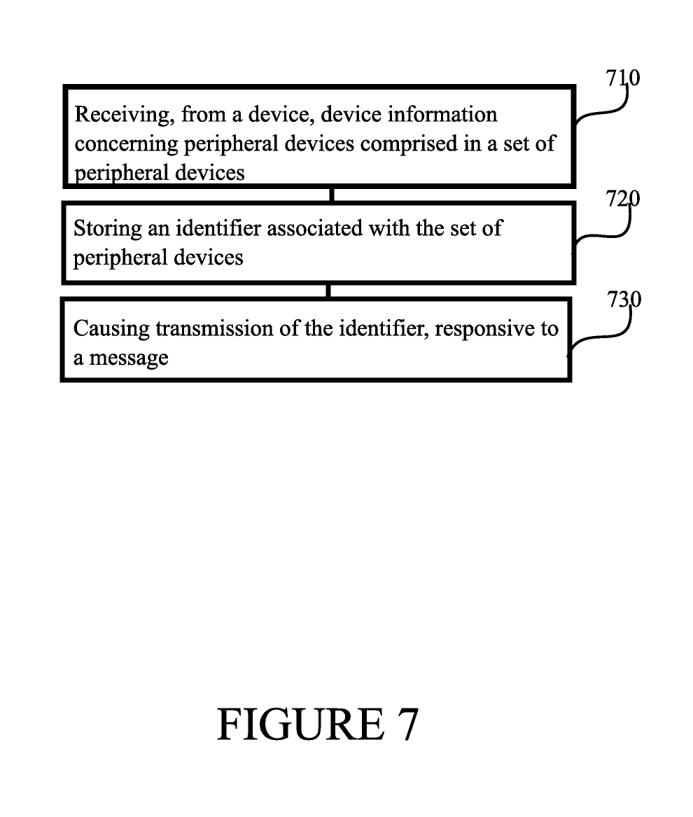

FIG. 7 is a third flow chart of a second method in accordance with at least some embodiments of the present invention. The phases of the illustrated method may be performed in server 140, for example.

Phase 710 comprises receiving, from a device, device information concerning peripheral devices comprised in a set of peripheral devices. Phase 720 comprises storing an identifier associated with the set of peripheral devices. Finally, phase 730 comprises causing transmission of the identifier, responsive to a message. The identifier may comprise a docking center instance identifier. The phases of the illustrated method may cause a docking center instance identifier to become registered in a server performing the method.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, described features, structures, or characteristics may be combined in any suitable or technically feasible manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1-47. (canceled)

48. An apparatus comprising:
at least one receiver configured to obtain discovery information concerning a plurality of peripheral devices;
at least one processing core configured to define a set of peripheral devices from among the plurality of peripheral devices, and to cause transmission, to a server, of device information concerning each peripheral device comprised in the set.

49. The apparatus according to claim 48, wherein the apparatus is further configured to obtain credentials for at least one of the peripheral devices comprised in the set.

50. The apparatus according to claim 49, wherein being configured to obtain the credentials comprises being configured to request for at least one credential from a user.

51. The apparatus according to claim 48, wherein the set of peripheral devices comprises a virtual docking center instance.

52. The apparatus according to claim 48, wherein the at least one receiver is configured to receive the device information over a low-power wireless interface.

53. The apparatus according to claim 49, wherein the at least one processing core is configured to cause transmission of the credentials in connection with transmission of the device information.

54. The apparatus according to claim 48, wherein the at least one processing core is configured to cause transmission of the device information responsive to a user interface input.

55. The apparatus according to claim 53, wherein being configured to cause transmission of the credentials in connection with transmission of the device information comprises being configured to cause transmission of the credentials and the device information comprised in a single message.

56. An apparatus, comprising:
at least one receiver is configured to receive, from a server, an indication of a set of peripheral devices that is available, and
at least one processing core configured to obtain, from the server, device information concerning the set of peripheral devices, and to cause the apparatus to connect directly with the set of peripheral devices based at least in part on the device information to initiate a wireless docking session.

57. The apparatus according to claim 56, wherein the indication comprises an identifier of the set of peripheral devices.

58. The apparatus according to claim 56, wherein the at least one processing core is configured to cause transmission, toward the server, of at least one identifier of at least one peripheral device comprised in the set of peripheral devices, and the apparatus is configured to responsively receive the indication.

59. The apparatus according to claim 56, wherein the apparatus is configured to inquire from a user whether to connect with the set of peripheral devices.

60. The apparatus according to claim 56, wherein the apparatus is configured to obtain from the server at least one of: credentials, device information, connectivity information and access information concerning the available set of peripheral devices.

61. The apparatus according claim 60, wherein the apparatus is configured to control the available set of peripheral devices, at least in part, using at least one of: the credentials, other device information, connectivity information and access information.

62. The apparatus according to claim 56, wherein the apparatus is configured to connect with the set of peripheral devices using direct low-power wireless connections, the direct low-power wireless connections not traversing any nodes between the apparatus and the peripheral devices comprised in the set of peripheral devices.

63. An apparatus, comprising:
a receiver configured to receive, from a device, device information concerning peripheral devices comprised in a set of peripheral devices;
a memory arranged to store an identifier associated with the set of peripheral devices;
at least one processing core configured to, responsive to a message, cause transmission of the identifier.

64. The apparatus according to claim 63, wherein the receiver is further configured to receive credentials for at least one of the peripheral devices comprised in the set.

65. The apparatus according to claim 63, wherein the at least one processing core is configured to, responsive to the message from the device, cause transmission of at least one of:
credentials, device information, connectivity information and access information concerning the available set of peripheral devices.

66. The apparatus according to a claim 63, wherein the message comprises an inquiry as to whether a wireless docking opportunity exists.

67. The apparatus according to claim 63, wherein the message comprises second device information, and the at least one processing core is configured to compare the device information to the second device information.
